(19) United States
(12) Patent Application Publication
(10) Pub. No.: US 2026/0247083 A1
(43) Pub. Date: Aug. 20, 2026

(54) EAR-WEARABLE DEVICE WITH DIFFERENT DIRECTIONAL MODES

(71) Applicant: Starkey Laboratories, Inc., Eden Prairie, MN (US)

(72) Inventors: Alaganandan Ganeshkumar, North Attleboro, MA (US); Jinjun Xiao, Chanhassen, MN (US); Jinjing Xu, Eden Prairie, MN (US); Larissa Anne Taylor, Edina, MN (US); Xiaojian Lu, Bryn Mawr, PA (US); Shivakrishna Charka, Hyderabad (IN); Lavanya Vimal Kumar, Leander, TX (US)

(21) Appl. No.: 19/535,426

(22) Filed: Feb. 10, 2026

Related U.S. Application Data
(60) Provisional application No. 63/760,673, filed on Feb. 20, 2025.

(51) Int. Cl. H04R 25/00; H04S 7/00; G10L 25/30; G10L 25/84

(52) U.S. Cl. CPC H04R 25/407; H04R 25/507; H04S 7/304; G10L 25/30; G10L 25/84; H04R 2225/43; H04R 2225/61; H04R 2430/01; H04S 2400/11; H04S 2400/15; H04S 2420/07

(57) ABSTRACT

Enhancing sound in an ear-wearable device involves receiving an ambient sound stream from a microphone of an ear-wearable device and inputting a representation of the ambient sound stream to a deep neural network that is trained to detect speech in a noisy environment. In response to detecting the speech via the deep neural network, the ear-wearable device operates in a directional mode in which an audio representation derived from the ambient sound stream is emphasized in a target direction. In response to detecting no speech via the deep neural network, the ear-wearable device operates in a spatial omnidirectional mode in which a fixed directional mode signal is combined with an omnidirectional signal to provide the audio representation. The fixed directional mode signal and the omnidirectional signal operate over different frequency ranges.

This application claims the benefit of U.S. Provisional Application No. 63/760,673, filed February 20, 2025, the disclosure of which is incorporated by reference herein in its entirety.

### SUMMARY

This application relates generally to ear-level electronic systems and devices, including hearing aids, personal amplification devices, and hearables. In one embodiment, a method enhances sound in an ear-wearable device. The method is implemented via a processor of the ear-wearable device and involves receiving an ambient sound stream from a microphone of the ear-wearable device. A representation of the ambient sound stream is input to a deep neural network that is trained to detect speech in a noisy environment. In response to detecting the speech via the deep neural network, the ear-wearable device is caused to operate in a directional mode in which an audio representation derived from the ambient sound stream is emphasized in a target direction. In response to detecting no speech via the deep neural network, the ear-wearable device is caused to operate in a spatial omnidirectional mode in which a fixed directional mode signal is combined with an omnidirectional signal to provide the audio representation, the fixed directional mode signal and omnidirectional signal operating over different frequency ranges. The audio representation is sent to a receiver of the ear-wearable device for reproduction in an ear of a user.

The figures and the detailed description below more particularly exemplify illustrative embodiments.

### BRIEF DESCRIPTION OF THE DRAWINGS

The discussion below makes reference to the following figures.

FIG. 1 is an illustration of ear-wearable devices according to an example embodiment;

FIG. 2 is a block diagram showing a sound processing system according to an example embodiment;

FIGS. 3 and 4 are block diagrams showing directionality modes of an ear-wearable device according to example embodiments;

FIGS. 5 and 6 are block diagrams showing sound processing paths according to example embodiments;

FIGS. 7A and 7B are plots showing directional mode sensitivities according to example embodiments;

FIGS. 8A and 8B are flowcharts showing directional mode selection criteria according to example embodiments;

FIGS. 9A and 9B are diagrams showing division of frequencies between the spatial and omnidirectional modes according to example embodiments;

FIGS. 10A and 10B are diagrams illustrating aspects of a directional omni mode.

FIG. 10C is a flowchart showing directional mode switching interactions according to another example embodiment;

FIG. 11 is a block diagram showing implementation of a spatial omnidirectional mode according to an example embodiment;

FIG. 12 is a flowchart of a method according to an example embodiment;

FIG. 13 is a block diagram of a hearing device and system according to an example embodiment; and

FIG. 14 is a block diagram of a system according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” “ear-wearable devices,” and “audio wearables”), such as hearables (e.g., wearable earphones, ear monitors, and earbuds), hearing aids, hearing instruments, and hearing assistance devices, typically include an enclosure, such as a housing or shell, within which internal components are mounted or disposed.

Embodiments described herein relate to audio enhancement features in an ear-wearable device, such as noise reduction and speech enhancement. The current situation in which the embodiments are intended for use involves the widespread use of audio wearable (AW) devices, such as earbuds, hearing aids, and other wearable audio devices, in various environments. These devices are commonly used by individuals seeking to listen to music, communicate, or enhance their hearing abilities, e.g., to compensate for hearing impairment.

One challenge faced by users of AW devices is the loss of spatial awareness. Spatial awareness in this context is the understanding and perception of the space around oneself and the objects within that space based on audio cues. Audio spatial awareness, combined with other senses, informs people about where they are and objects that are in the surroundings. The ability to determine the direction of a sound source is a natural skill in people with normal hearing, allowing them to determine where objects are in the surroundings, and thus being able to connect and navigate through space effectively. Those with spatial hearing loss may have difficulty discerning spatial cues, which may impair the ability to interact verbally with others, among other things.

Spatial hearing impairment can occur at any age, although is most often associated with age-related hearing loss. One challenge faced by AW listeners is the loss of spatial awareness caused by wearing an AW device, which can reduce the natural spatial cues that the ear pinna provides. In other cases, some AW devices automatically switch to directional processing modes in noisy environments to help enhance speech understanding. Directional processing involves emphasizing sounds in certain directions, typically the forward hemisphere of the user, and may also reduce noise in non-preferred directions. Directional modes are typically realized by combining signals from multiple microphones in a way that can emphasize sound in some directions, a technique commonly referred to as beamforming.

Directional modes have been found to cause some issues, such as reduction of audibility of environmental sounds especially from rear and reduction of speech intelligibility for off axis speech. These and other artifacts can impair spatial localization as well as increased audibility of annoying noise artifacts such as wind noise. Embodiments described below employ directionality techniques that are designed to overcome these issues. These techniques can restore some of the lost pinna spatial cues in higher frequencies. In some embodiments, a neural network speech detector can be used such that directional processing may only be engaged when speech is detected. These features preserve the advantages of directional processing when needed but otherwise restore some of the lost spatial awareness caused by the AW device in normal everyday listening

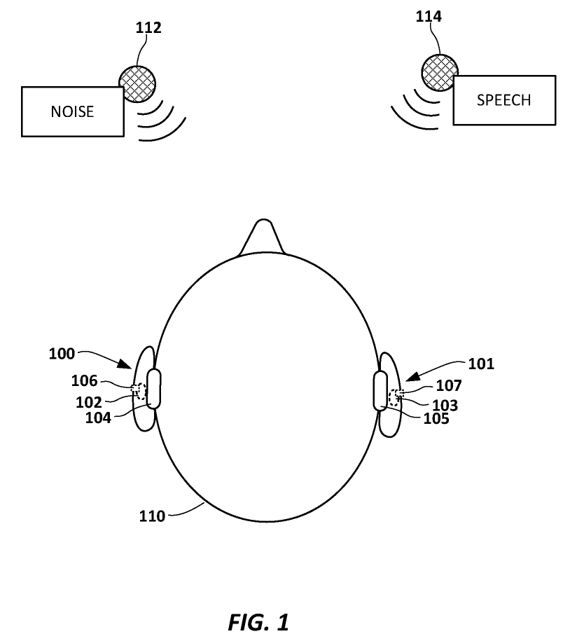

In FIG. 1, a diagram illustrates an example of ear-wearable devices 100, 101 according to an example embodiment, also referred to below as hearing devices. Both left and right ear-wearable devices 100, 101 are shown, each include a respective in-ear portion 102, 103 that fit into respective ear canals of a user/wearer 110. The ear-wearable devices 100, 101 may also include respective external portions 104, 105, e.g., worn over the back of the outer ear. The external portions 104, 105, if provided, are electrically and/or acoustically coupled to the internal portions 102, 103.

One or both of the in-ear portions 102, 103 and external portions 104, 105 may include an acoustic transducer, referred to herein as a “receiver,” “loudspeaker,” etc., although could include a bone conduction transducer. If the acoustic transducer is located on the external portions 104, 105, it may be acoustically coupled to the user’s ear via a tube and earpiece.

One or both of the in-ear portions 102, 103 and external portions 104, 105 may include an external microphone, as indicated by respective microphones 106, 107. The external portions 104, 105, if included, may each have two microphones, e.g., front and rear microphones (not shown). Generally, an external microphone is situated to pick up sounds originating away from the user 110, as opposed to an internal microphone that is configured to pick up sounds within the ear canal.

Other components of hearing devices 100, 101 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing devices 100, 101 can incorporate a wireless communication interface, such as a Bluetooth® transceiver or other type of radio frequency (RF) transceiver, which can be used to communicate with each other and with external devices as described below.

While FIG. 1 shows one example of a hearing device, the term “hearing device” of the present disclosure may refer to a wide variety of ear-level electronic devices that can aid a person with or without impaired hearing. This includes devices that can produce processed sound for persons with normal hearing, such as noise addition/cancellation to treat misophonia, or wireless earbuds for electronic sound playback. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

As seen in FIG. 1, the user 110 may be in an environment with multiple sources of sound, here simplified to two sources, noise 112 and speech 114. The sounds may emanate from more than just single locations. For example, in an environment such as a moving vehicle, noise may generally surround the user instead of appearing to originate from a single point. Nonetheless, the ear-wearable devices 100, 101 may classify a current audio stream as one of these two categories, and make changes to directional sensitivity based on that classification. There may be other categories besides speech and noise, such as music, electronic sounds/alerts, etc., that may be treated differently from noise 112. Often, the user 110 will prioritize speech 114 over other categories, and so the embodiments below may prioritize speech clarity over other objectives. Nonetheless, such techniques can be adapted for using in prioritizing other types of identifiable sounds for specialized applications.

The ear-wearable devices 100, 101 are equipped with a sound enhancement utility that utilizes one or more Deep Neural Networks (DNN). The DNNs are capable of operating in real-time and may always be active, e.g., integrated into embedded Digital Signal Processing (DSP) hardware. The DNN is trained to detect when speech is present in the ambient sound stream. At times when speech is detected, the AW device switches to a mode that enhances a user's ability to listen to the target speaker in certain directions. This can help restore the spatial cues in certain directionality modes while without impairing the speech intelligibility benefits provided by other processing modules of the device.

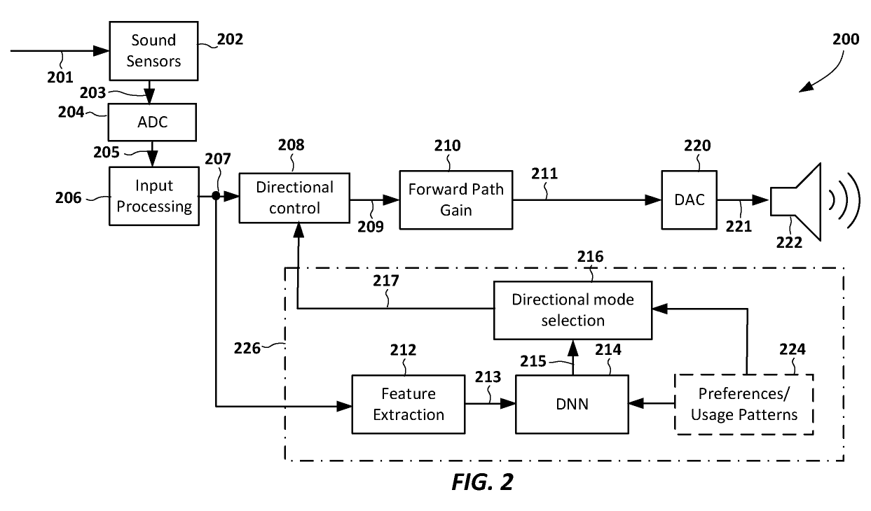

The ear-wearable devices 100, 101 may use a signal processing system 200 for enhancing spatial awareness as shown in FIG. 2. The signal processing system 200 detects incoming sound 201 at a sound sensor 202, e.g., a microphone. The signal processing system 200 can be designed to accommodate both single-microphone and multi-microphone configurations. For example, where the ear wearable devices are capable of beam forming to provide directional modes, at least two microphones will be present on each device.

An analog signal 203 from the sound sensor 202 is input to an analog-to-digital converter (ADC) 204, which converts the analog signal to a digital bit stream 205 that is processed by input processing block 206. The input processing block 206 may, for example, perform conditioning on the digital bit stream 205 from the ADC 204, such as filtering, assembling into processing blocks/frames for fast Fourier transform (FFT) or weighted overlap add (WOLA) processing, etc.

A directional controller 208 receives multi-channel audio data 207 from the input processor and provides directional processing as described below, resulting in a directionally processed bit stream 209. The forward path gain block 210 applies selective gain and/or attenuation the bit stream 209 to emphasize or deemphasize certain aspects of the sound, e.g., to apply equalization to compensate for a hearing condition. The forward path gain block 210 may provide other processing, e.g., speech enhancement, noise reduction, feedback suppression, etc. The output bit stream 211 from the forward gain block 210 is sent to digital-to-analog converter (DAC) 220. The DAC 220 provides an analog signal 221 used to drive a receiver 222.

A directionality control subsystem 226 receives the multi-channel audio data 207, where it analyzes one or more of the channels to detect speech in the data stream. The directionality control subsystem 226 includes a feature extraction block 212, DNN 214 and directional mode selection block 216. The DNN 214 is trained to detect speech in a noisy environment, and may provide as a speech presence output 215 a speech presence probability (SPP) indicator or the like. The feature extraction block 212 extracts features 213 which are mapped onto an input layer of the DNN 214. The speech presence output 215 output is used estimate a current probability that speech is present in the digital bit stream 207. More details of speech detecting DNN can be found in commonly-owned provisional patent application 63/683,301, filed 15 August 2024 (Attorney Docket Number ST01083US60PRV/0532.001083US60, hereinafter “’301 reference”), which is hereby fully incorporated by reference.

The DNN in the ‘301 reference is trained to provide a signal-to-noise ratio (SNR) driven mask (SDM) 309. Generally, the SDM provides a frequency variable gain value based on signal to noise ratio (SNR) that is be applied to a noisy speech signal. The SDM is processed via a weighted average block that weights and averages the SDM with perceptual weights, such as those associated with the Speech Intelligibility Weighting Function. The SDM weighting can be time-varying. One could apply a time-frequency weighting to boost the time-frequency blocks where speech is dominant and attenuate time-frequency blocks where speech is not present. This is called a time-frequency mask. The DNN in the ‘301 reference may include at least one of a recurrent neural network, a transformer network, and an encoder-decoder.

In reference again to FIG. 2, the directional mode selection block 216 receives the speech probability output 215 from the DNN 214. In response, the selects a mode 217 that changes how sound is processed by a directional control component 208, e.g., using a beam steering algorithm. In response to detecting the speech via the DNN 214, the directional control component 208 is switched to operate in a directional mode in which an audio representation derived from the ambient sound stream is emphasized according to a particular spatial pattern. In response to the DNN 214 not detecting the speech, the directional control component 208 is switched to operate in a spatial omnidirectional mode in which a fixed directional mode signal is combined with an omnidirectional signal to provide the audio representation. The fixed directional mode signal and omnidirectional signal operate over different frequency ranges.

Note that the DNN 214 provides an estimate of the existence of speech in the input features 213, such as a probability that speech is present, an intelligibility score if speech is present, etc. Thus the determinations of speech presence may be based on one or more outputs 215 of the DNN 214 satisfying a threshold. For example, if speech is detected to a probability just below a detection threshold, the DNN 214 will indicate there is no speech present even though there is a probability that speech might be present. A similar determination is made to signal speech is present, although a different detection threshold may be used. Such probabilities and thresholds may change based on context, e.g., levels of surrounding noise, modes and configurations of the device, etc.

The DNN output 215 informs the directional system about the presence or likelihood of speech, enhancing its intelligence. Unlike other means of informing directionality, the spatial awareness training of the DNN 214 can restore the spatial cues in certain directionality modes, while keeping the same or improving the speech intelligibility. Among other benefits, the described embodiments can improve spatial awareness and localization in noise and/or improve the understanding of speech coming from side or back.

The DNN-informed information in the SPP output 215 is effective in detecting non-stationary noise. The SPP output 215 may be a figure of merit ranging between 0.0 and 1.0. In such an embodiment, an SPP value of 1.0 indicates the highest probability of speech and 0.0 indicates the lowest probability. The SPP output value 215 may be somewhere in between, but may be thresholded (e.g., set to zero or one) for subsequent processing, e.g., within the mode selector 216. The DNN 214 may be trained to provide similar outputs that estimate other targeted types of sounds, such as music, machine sounds (e.g., phone ringing), animal sounds, etc.

As indicated by block 224, the DNN 214 and/or mode selector block 216 may be configurable based on any combination of (e.g., one or both) individual hearing preferences or usage patterns. For example, the user may disable SPP estimation or select a maximum amount that it can affect directionality. In other embodiments, DNN weights and/or selector settings may be changed based on current conditions, e.g., high/low noise environments, whether the user is using the device for a non-speech purpose such as listening to music, sleep detection, etc.

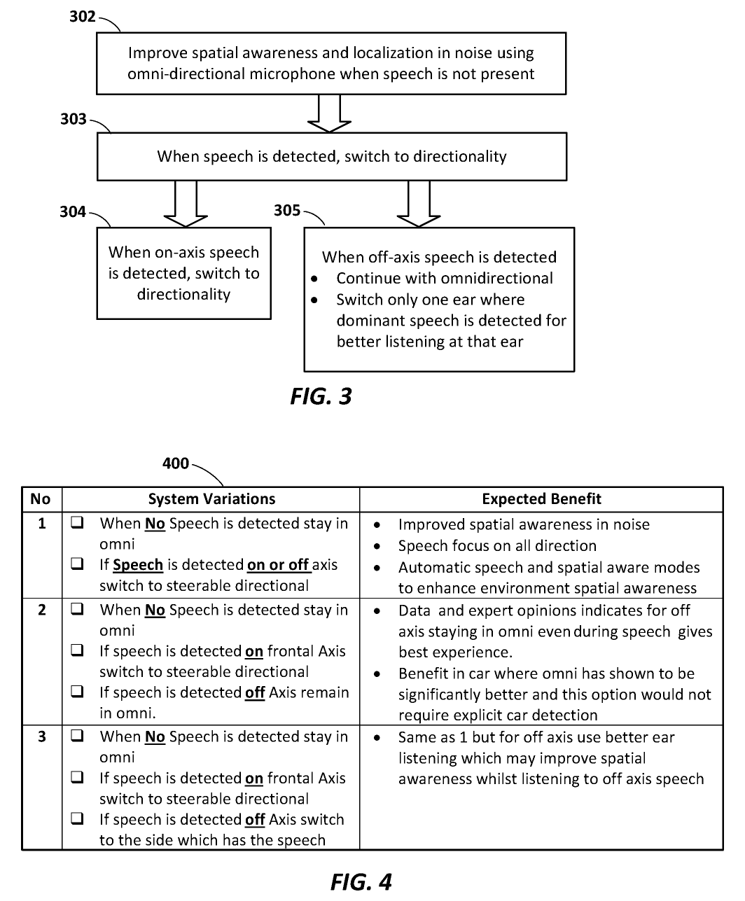

The schematic diagram in FIG. 2 shows operational components (e.g., software modules, digital signal processor (DS) subsystems) that can generally interact to improve spatial awareness according to various schemes. An example scheme is shown in the block diagram of FIG. 3. Block 302 represents processing when speech is not present. Generally, this involves using an omnidirectional mode and/or spatial omnidirectional mode as described above. As block 302 indicates, when speech is detected, a directionality mode is selected. Blocks 304 and 305 indicate two directionality options once speech is detected. At block 304, on-axis speech (e.g., generally in front of the user) is detected, in which case a forward directionality mode is used. Block 305 is for an off-axis speech. At block 305, off-axis speech (e.g., generally to the side and/or behind the user) is detected, in which case an omni-directional mode is maintained, optionally combined with one ear (e.g., the ear closest to the sound) being switched to a directional mode.

If the switching shown at block 303 occurs too quickly, this could be perceived as an unpleasant artifact, e.g., a repeated narrowing and broadening of the acoustic scene each time there is a start and stop in speech, such as during short pauses in speech. In one embodiment, the system can be configured to capture major noise-only segments (e.g., 30 seconds or longer) and only switch after SPP changes have stabilized over this time. Other ways of dealing with rapid switching of directional modes including smoothing the SPP signals and using different attack/release time constants.

In block 302, an omni-directional mode is used where no speech is present, as studies suggest this mode performs best for spatial environmental awareness. This is somewhat intuitional, as one would expect that preserving sound in all directions as much as possible is better for detecting spatial cues rather than creating acoustic nulls from a directional pattern. In some environments, such as in a moving car, omni-directional can perform better than directional even when speech is present. This may be due in part because existing directionality algorithms tend to focus on the front hemisphere within a short distance, and car speech is quite often from the side.

In FIG. 4, a table 400 shows variations on how a switchable directional mode device may operate according to various embodiments. The first row of table 400 is a simplified version of what is shown in FIG. 3, in that a directional mode is used whether speech is on or off axis. Also note that “staying in omni” may refer to spatial omnidirectional mode as described elsewhere, as well as in a standard omnidirectional mode. This table 400 also refers to a ‘steerable directional’ mode (also referred to as ‘DNN beta’), which allows determining a primary direction that may be on or off axis from which speech is detected. In one embodiment, this uses a DNN that is trained to provide a value (beta) that indicates a direction that will result in maximizing a signal to noise ratio of speech, thus providing an indicator of direction from which the speech originates. Additional details of the DNN beta implementation is described in commonly owned patent application __/___,___, filed ______ (Attorney Docket Number 0532.001100US60), which is hereby incorporated by reference.

In the second row of table 400, the steerable direction mode is used if on-axis speech is detected (on or about the frontal axis), which may include a range of frontal angles relative to forward vision (0 degrees) of the user. For example, the frontal axis may include ±90º, ±60º, ±30º, etc. This can be extended to three-dimensional space, e.g., a front hemisphere or portion thereof. The third row of table 400 is the same as the second row, except that a side on which off-axis speech is detected is emphasized, which may also or instead involve deemphasizing the opposite side.

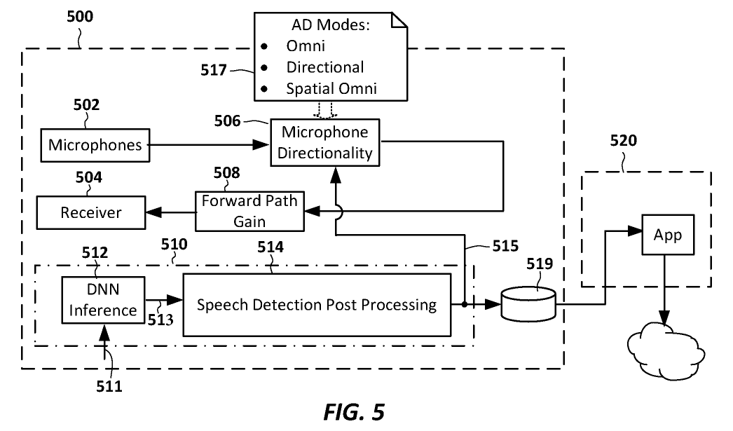

In FIG. 5, a block diagram shows aspects of an ear-wearable device 500 according to an example embodiment. The device 500 includes components previously described in FIG. 2, such as microphones 502, receiver 504, and directionality control 506. Block 508 generally represents forward processing as described in FIG. 2. Subsystem 510 includes DNN-based speech detection, which includes a DNN inference model 512 that outputs SPP 513 based on features 511 extracted from microphone signals, e.g., frequency domain features, weighted overlap add (WOLA) frames, etc. Block 514 processes the SPP 513, e.g., smoothing and/or thresholding outputs to prevent excessive switching of directionality modes. The processed SPP 515 is provided to the microphone directionality control 506. The directionality control 506 may select from a number of modes 517 based on whether the processed SPP 515 indicates presence of speech in the audio stream from which the features 511 were extracted. The SPP 515 may be stored in a memory 519 (volatile or non-volatile), where it can be accessed by a mobile device 520.

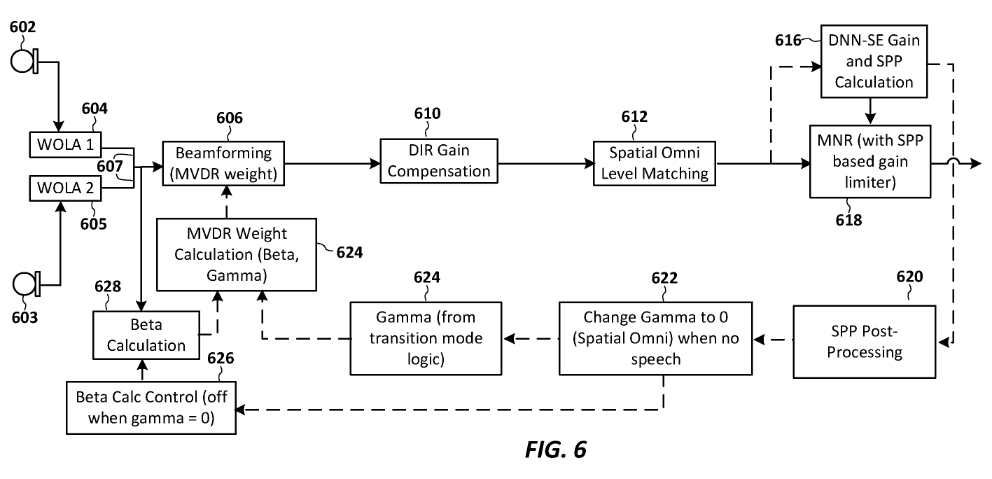

In FIG. 6, a block diagram shows additional implementation features of a ear-wearable device according to various embodiments. The signals from two or more microphones 602, 603 are preprocessed via WOLA filterbanks 604, 605 which provide the filtered frequency domain data 607 to a Minimum Variance Distortionless Response (MVDR) beamformer 606. Outputs of the beamformed data streams are further processed by directional mode (DIR) gain compensation 610, and spatial omnidirectional level matching 612. As previously noted, a DNN-based processor 616 has a trained model for determining SPP. The model may also, as shown here, use the same or different trained model for determining speech enhancement (SE) gain. Block 618 determines mask-to-noise ratio (MNR), which is the signal-to-noise ratio (SNR) minus the signal-to-mask ratio (SMR), which improves the perceptual quality of the processed audio stream. The accuracy of the masking level calculation is determinative to the accuracy of the psychoacoustic unit. The SPP output of block 618 is analogous to a feedback control signal of a closed loop controller, which changes characteristics of the beamformer based on the likelihood that speech is present.

At block 620, the SPP is post-processed (e.g., smoothed) where it is used to set a gamma value at block 624 that controls directional modes. At indicated at block 622, the value of gamma is zero when no speech is detected. This is used to control calculation of beta value at block 628, e.g., to turn off beta calculation at block 626 when gamma is zero. In other words, when no speech is detected, directional steering of the beamformer is not used. Block 624 represents the use of both gamma and beta to calculate the MVDR weights for the beamformer 606. Note that in any of these embodiments, the same DNN may be trained to detect both SPP and beta, thus combining the functionality of blocks 616 and 628.

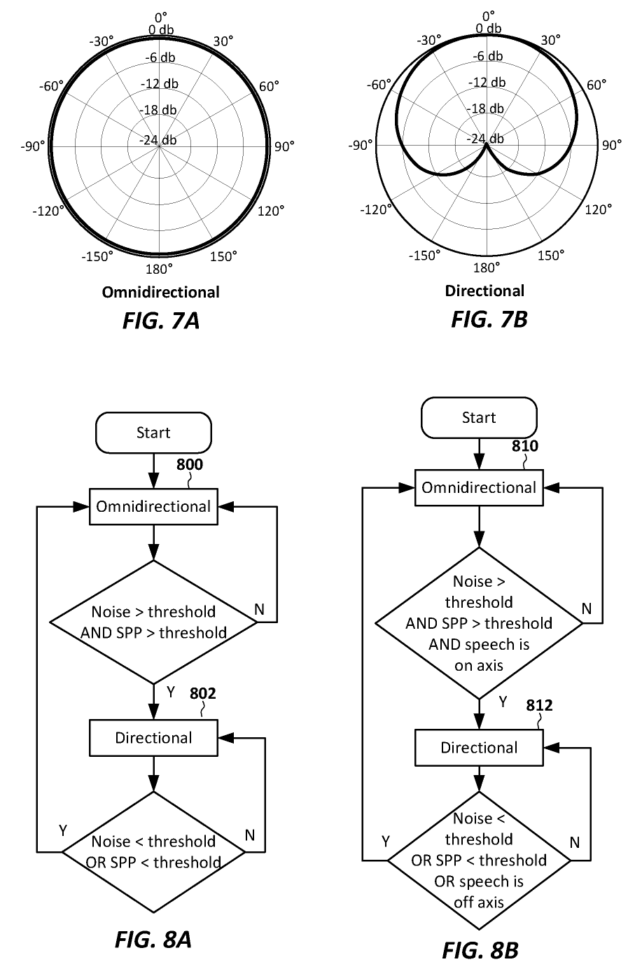

In FIGS. 7A and 7B, polar plots show examples of respective omnidirectional and directional patterns that may be implemented in a hearing device according to example embodiments. The directional pattern in FIG. 7B is a cardioid pattern with maximum sensitivity at 0º (corresponding to forward view direction of the user) and a null (minimal sensitivity or gain) directly behind the user at 180º. In other embodiments described below, a cardioid pattern such as in FIG. 7B may be rotated about the center of the plot for various beta values. For purposes of the description of FIGS. 8A and 8B, it may be assumed that patterns the same or similar to what is shown in FIGS. 7A and 7B are used in the various modes.

In FIGS. 8A and 8B, flowcharts show alternate embodiments of directional mode selection algorithms. In FIG. 8A, omnidirectional mode 800 is entered by default, or when noise and SPP are above respective noise and speech detection thresholds. Directional mode 802 is entered when at least one of noise or SPP are below respective noise and speech detection thresholds. Thus, directionality is only used in noisy environments where speech is detected. In FIG. 8B, omnidirectional mode 810 is entered by default, or when noise and SPP are above respective noise and speech detection thresholds, and speech is detected on-axis, e.g., frontally located. Directional mode 812 is entered when at least one of noise or SPP are below respective noise and speech detection thresholds, or speech is detected off-axis, e.g., from behind and/or the side. In this case, directional mode is only used in noisy environments where speech is detected directly ahead. The references to directional mode in FIGS. 8A and 8B may include modes where steering is used. The references to omnidirectional mode in FIGS. 8A and 8B may include spatial omnidirectional mode.

The spatial omnidirectional provides an audio signal that combines an appropriately scaled omnidirectional microphone signal a fixed directional microphone signal. The fixed directional signal and omnidirectional signal operate over different frequency ranges, e.g., a first set of N-frequency processing bands and a second set of M-frequency processing band. The values of N and M may be different or the same.

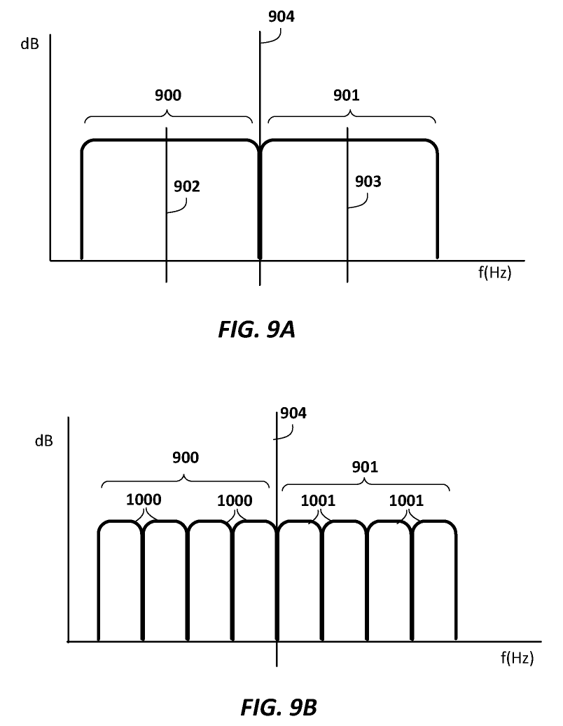

In FIG. 9A, a diagram shows division of frequencies between the spatial and omnidirectional modes according to an example embodiment. An ear-wearable device provides a sound stream that includes ambient sound measured via microphones, and may have already gone some processing (e.g., WOLA). A sound processor divides the sound stream into different first and second frequency-defined bands 900, 901. The bands 900, 901 define/correspond to parts/versions/substreams of the sound stream that are limited within the bands 900, 901. First data (e.g., a first substream) corresponding to the first band 900 is used to provide the omnidirectional signal and second data corresponding to the second band 901 used to provide the fixed directional mode signal.

The first and second bands 900, 901 may be defined by respective first and second center frequencies 902, 903. This figure shows the second center frequency 903 of the second band 901 being higher than a corresponding first center frequency 902 of the first band 900. The fixed directional mode signal provides fixed directionality in the higher-frequency second band 901 to preserve localization cues. The center frequencies 902, 903 may refer to a center along linear or logarithmic scales. While the bands 900, 901 are shown in this embodiment as separate and non-overlapping, there may be some overlap therebetween, e.g., responses may overlap below some perceptible sound pressure level. In other embodiments, the first and second bands may be defined with an intentional overlap, e.g., if some frequencies provide useful information for both directional and omnidirectional modes. Also, widths of the bands 900, 901 are shown equal in FIG. 9, however the bands could be of different bandwidths, e.g., as defined by energy, power spectral densities and/or frequency extents.

A cutoff frequency 904 demarcates/defines a boundary between the first and second bands 900, 901. The cutoff frequency 904 defines a frequency above which audible cues are prevalent, e.g., 4-6 kHz. Generally, a DSP may provide a selectable number of signal sub-bands for processing as separate data streams. As shown in FIG. 9B, the first band 900 may include a first set of first N-sub-bands 1000 and the second band 901 may include a second set of second N-sub-bands 1001. The value of N in this figure is four, however more typically will be a higher number, e.g., N = 7, 8, 9, 10, etc. In this example, the first and second sets 1000, 1001 are disjoint, meaning a particular sub-band will be in only one set. It is possible in some cases to define sets which utilize a same sub-band, e.g., both sets may include one of the sub-bands near the cutoff frequency 904. This may be analogous to overlapping between the first and second bands described above.

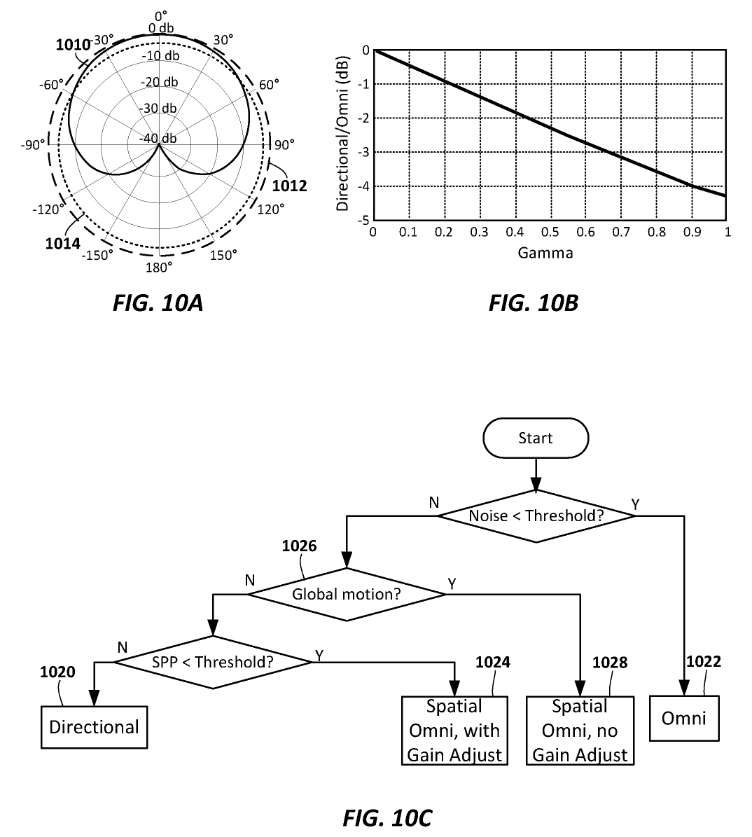

In FIGS. 10A and 10B, plots show details of implement gain matching according to an example embodiment. In FIG. 10A, a static cardioid polar pattern 1010 is shown that is typical of a directional signal at the first frequency band. The dashed circle 1012 indicates a non-attenuated omnidirectional signal (e.g., at the second frequency band). The dotted circle 1014 represents an attenuated (scaled) omnidirectional signal. The scaling of the omni directional signal maintains the same overall noise perception level as would be perceived by a directional system in a noise-only condition.

This scaling mechanism may also be referred to as gain matching. Gain matching ensures that the spatial information from rear region is enhanced while the noise level from front region is reduced. Gain matching is used so that users do not perceive an objectionable change in overall noise level when switching from spatial omni to directionality or vice versa. Maintaining fixed directionality in higher frequency bands helps to preserve localization cues similar to unaided pinna directionality.

To ensure the system works smoothly and doesn’t cause artifacts, careful consideration is given to choosing appropriate transition time constants and hold times in the overall design. As seen in FIG. 10B, the scaling may be adjusted based on the value of gamma, which is a measure of when speech is detected (gamma=1) or not (gamma=0). The gain matching is highest when speech is detected.

In some cases, gain matching may be inhibited, such as when motion is detected via an inertial measurement unit. Reduction in gain may limit the user’s ability to hear the environmental sounds when detected motion exceeds a threshold, e.g., when the user is walking or running. This is shown in the flowchart of FIG. 10C, which shows directional mode selection according to another embodiment. As with other examples, a directional mode 1020 is selected in a noisy environment where speech probability is above a threshold. Similarly, if there is low noise and no speech detected, then an omni mode 1022 is used as a default. If speech probability is below the threshold in the noisy environment, then spatial omni mode with gain adjustment 1024 is selected. The exception is if global motion is detected at block 1026, in which case spatial omni mode with no gain adjustment 1028 is selected.

To enable the DNN based speech detector to work on the best SNR signal for speech detection, a background MVDR directional system can be deployed when in spatial omnidirectional mode. In such a case, the output of the background MVDR directional system can preprocess the data to select a directional signal pattern that is then decomposed into input features of the DNN.

The embodiments described above can be further extended with an off axis speech detector. When triggered, the off-axis speech detector will not transition to a directional system but instead will transition from spatial omnidirectional mode to a full omnidirectional mode or a spatial omnidirectional mode with a different level of gain matching factor. The DNN described herein may be extended to include features from multiple microphone input streams to determine not only if speech is detected, but which direction the speech is coming from (the ‘beta’ value described above).

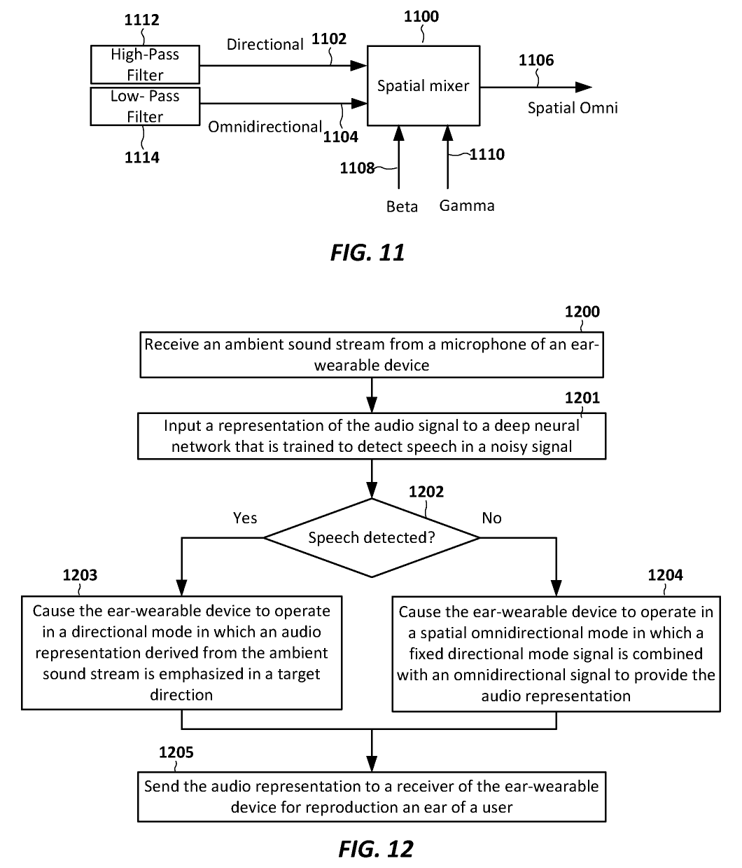

There are a number of ways to implement the spatial omnidirectional mode. One option is shown in FIG. 6, where the beamformer 606 sets the mode via the MVDR weight calculation 624, after which block 612 performs level matching by scaling the omnidirectional signal to maintain a same overall noise perception level as would be perceived by a directional system in a noise-only condition. Another embodiment is shown in the block diagram of FIG. 11. A spatial mixer module 1100 in the main audio path is configured to mix between a directional signal 1102 and omnidirectional signal 1104 to produce the gain-matched spatial omni signal 1106.

The omnidirectional signal 1104 may be a combined audio stream from all microphones without any beam steering applied, while the directional signal 1102 may be processed by a directional MVDR beamforming algorithm or the like. The signals 1102, 1104 operate over different frequency bands, as illustrated schematically by high pass filter 1112 and low pass filter 1114 which partitions the signals in the previously mentioned frequency-defined bands. The values of one or both of beta 1108 and gamma 1110 may optionally be considered when gain matching, as the amount and direction of speech may be relevant in choosing the ratio of the signals 1102, 1104 that are combined into the output 1106.

In FIG. 12, a flowchart illustrates a processor implemented method of enhancing sound in an ear-wearable device according to an example embodiment. The method involves receiving 1200 an ambient sound stream from a microphone of the ear-wearable device. A representation of the ambient sound stream (e.g., frequency domain features) is input 1201 to a deep neural network that is trained to detect speech in a noisy environment, e.g., in a signal comprising both ambient background noise and speech. In response to detecting the speech via the deep neural network (block 1202 returns ‘yes’), the ear-wearable device is caused 1203 to operate in a directional mode in which an audio representation derived from the ambient sound stream is emphasized in a target direction.

In response to detecting no speech via the deep neural network (block 1202 returns ‘no’), the ear-wearable device is caused 1204 to operate in a spatial omnidirectional mode in which a fixed directional mode signal is combined with an omnidirectional signal to provide the audio representation. The fixed directional mode signal and omnidirectional signal operate over different frequency ranges, e.g., are bandwidth limited to respective first and second frequency ranges. The audio representation from either processing path is sent 1205 to a receiver of the ear-wearable device for reproduction in an ear of a user.

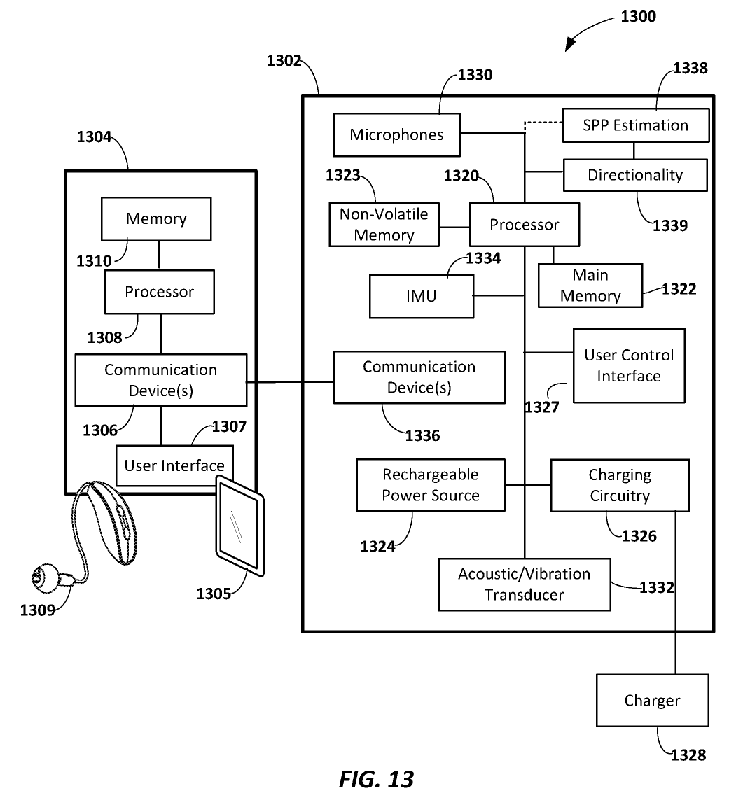

In FIG. 13, a block diagram illustrates a system and ear-wearable/hearing device 1300 in accordance with any of the embodiments disclosed herein. The hearing device 1300 includes a housing 1302 configured to be worn in, on, or about an ear of a wearer. The hearing device 1300 shown in FIG. 13 can represent a single hearing device configured for monaural or single-ear operation or one of a pair of hearing devices configured for binaural or dual-ear operation. Where two devices are used, they may be functionally equivalent, e.g., perform the same operations as least as it relates to directional processing. Functionally equivalent devices may still operate differently, e.g., having different physical form for left/right sides, having different ear canal fittings, having different sound processing settings to deal with ear-specific (left or right) pathologies, etc.

The hearing device 1300 shown in FIG. 13 includes a housing 1302 within or on which various components are situated or supported. The housing 1302 can be configured for deployment on a wearer’s ear (e.g., a behind-the-ear device housing), within an ear canal of the wearer’s ear (e.g., an in-the-ear, in-the-canal, invisible-in-canal, or completely-in-the-canal device housing) or both on and in a wearer’s ear (e.g., a receiver-in-canal or receiver-in-the-ear device housing).

The hearing device 1300 includes a processor 1320 operatively coupled to a main memory 1322 and a non-volatile memory 1323. The processor 1320 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 1320 can include or be operatively coupled to main memory 1322, such as RAM (e.g., DRAM, SRAM). The processor 1320 can include or be operatively coupled to non-volatile (persistent) memory 1323, such as ROM, EPROM, EEPROM or flash memory. As will be described in detail hereinbelow, the non-volatile memory 1323 is configured to store instructions (e.g., in module 1338) that enhance speech perception and spatial awareness through management of a directionality module 1339 as described elsewhere herein.

The hearing device 1300 includes an audio processing facility (also referred to as an audio processor circuit) operably coupled to, or incorporating, the processor 1320. The audio processing facility includes audio signal processing circuitry (e.g., analog front-end, analog-to-digital converter, digital-to-analog converter, DSP, and various analog and digital filters), a microphone arrangement 1330, and an acoustic/vibration transducer 1332 (e.g., loudspeaker, receiver, bone conduction transducer, motor actuator). The microphone arrangement 1330 can include two or more discrete microphones or a microphone array(s) (e.g., configured for microphone array beamforming). Each of the microphones of the microphone arrangement 1330 can be situated at different locations of the housing 1302. It is understood that the term microphone used herein can refer to a single microphone or multiple microphones unless specified otherwise.

The acoustic transducer 1332 produces amplified sound inside of the ear canal. For purposes of this disclosure, “amplified” sound refers to electronically reproduced sound, which typically involves the use of an amplifier to drive the acoustic transducer 1332. Amplified sound does not necessarily imply an increase in sound pressure level of ambient sounds relative to what would be experienced with the device removed. In some cases, the amplified sound may result in an overall sound pressure level similar to ambient, e.g., where an equalization curve is applied to affect a small frequency range. In other cases, amplified sound can reduce the sound pressure level in the ear, e.g., via active noise cancellation.

The hearing device 1300 may also include a user control interface 1327 operatively coupled to the processor 1320. The user control interface 1327 is configured to receive an input from the wearer of the hearing device 1300. The input from the wearer can be any type of user input, such as a touch input, a gesture input, and/or a voice input. The user control interface 1327 may be configured to receive an input from the wearer of the hearing device 1300.

The hearing device 1300 also includes a DNN-enabled, SPP estimation module 1338 operably coupled to the processor 1320. The module 1338 can be implemented in software, hardware (e.g., specialized neural network logic circuitry, general purpose processor), or a combination of hardware and software. During operation of the hearing device 1300, the module 1338 can be used to analyze audio signals generated from the microphone arrangement 1330 and generate an estimate of SPP and optionally direction of arrival (beta). These estimations are used by the directionality module 1339 to set a directional mode, and may be used by various other operational modules operable on the processor such as speech enhancement echo cancellation (not shown).

The hearing device may include other sensors, such as an IMU 1334 to determine an operating context of the hearing device 1300, e.g., in-ear, out-of-ear, etc., which can affect how the sound is analyzed and processed. The IMU 1334 can also be used to assist in the SPP estimation 1338, such as determining low frequency noise via accelerometers, detecting system disturbances, detecting travel in a vehicle, etc.

The hearing device 1300 can include one or more communication devices 1336. For example, the one or more communication devices 1336 can include one or more radios coupled to one or more antenna arrangements that conform to an IEEE 1302.13 (e.g., Wi-Fi®) or Bluetooth® (e.g., BLE, Bluetooth® 4.2, 5.0, 5.1, 5.2 or later) specification, for example. In addition, or alternatively, the hearing device 1300 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 1336 may also include wired communications, e.g., universal serial bus (USB) and the like.

The communication device 1336 is operable to allow the hearing device 1300 to communicate with an external computing device 1304, e.g., a mobile device 1305 such as smartphone, laptop computer, table, etc. The external computing device 1304 may also include a device usable by a clinician in a clinical setting, such as a desktop computer, test apparatus, etc. The external computing device 1304 may also include a second hearing device 1309, e.g. part of a pair of corresponding devices for both ears of the user.

The external computing device 1304 includes a communications device 1306 that is compatible with the communications device 1336 for point-to-point or network communications. The external computing device 1304 includes its own processor 1308 and memory 1310, the latter which may encompass both volatile and non-volatile memory. A user interface 1307 facilitates interactions between the external computing device 1304 and the hearing device 1300, including access to settings that affect the SPP estimation module 1338. The external computing device 1304 may perform some functions described herein associated with the hearing device 1300, such as SPP estimation using its own microphone (not shown) or via microphone 1330 of the hearing device 1300.

The hearing device 1300 also includes a power source, which can be a conventional battery, a rechargeable battery (e.g., a lithium-ion battery), or a power source comprising a supercapacitor. In the embodiment shown in FIG. 13, the hearing device 1300 includes a rechargeable power source 1324 which is operably coupled to power management circuitry for supplying power to various components of the hearing device 1300. The rechargeable power source 1324 is coupled to charging circuity 1326. The charging circuitry 1326 is electrically coupled to charging contacts on the housing 1302 which are configured to electrically couple to corresponding charging contacts of a charger 1328 when the hearing device 1300 is placed in the charger.

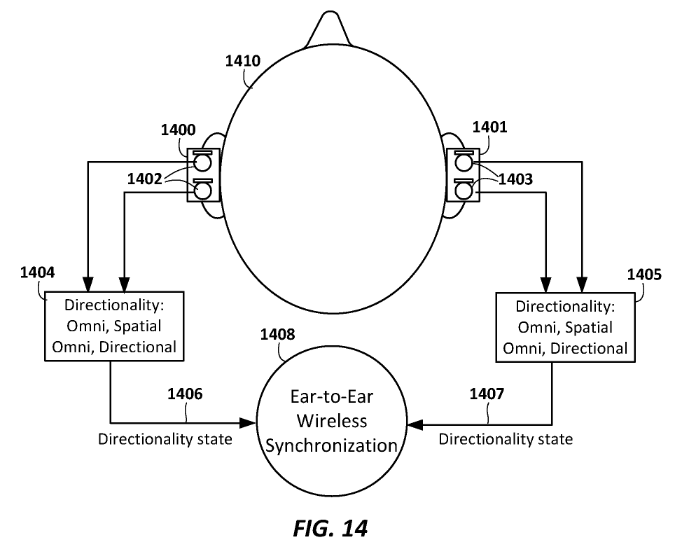

As noted above, two ear-wearable devices (e.g., devices 1300 and 1309 in FIG. 13) can operate as a system, and this can further extend the system’s ability to provide directional cues and speech enhancement. In FIG. 14, a diagram illustrates a system with two ear-wearable devices 1400, 1401 according to an example embodiment. Each device 1400, 10401 includes a respective pair 1402, 1403 of external microphones, although more than two external microphones may be used. Each device 1400, 10401 includes a directional processor as indicated by blocks 1404, 1405 that can switch between at least two modes (omnidirectional and spatial omnidirectional) and may also be able to switch to a third, directional mode.

Individual directionality states 1406, 1407 are communicated from the processing blocks to an ear-to-ear wireless synchronization processor 1408, which may run on one of the devices 1400, 1401, both of the devices 1400, 1401 cooperatively, or on another device, e.g., mobile phone. The processor 1408 can evaluate the individual directionality states 1406, 1407 to ensure the devices 1400, 1401 are presenting a coherent and consistent sound field to the user 1410. This may involve, for example, configuring the devices by changing directionality modes, gain values, beta values, etc., on one or both of the devices 1400, 1401. The processor 1408 may receive other data from the devices 1400, 1401 for this same purpose, such as SPP, beta, gamma, gain matching values, etc.

This document discloses numerous example embodiments, including but not limited to the following:

Example 1 is a method of enhancing sound in an ear-wearable device. The method is implemented via a processor of the ear-wearable device. The method comprises: receiving an ambient sound stream from a microphone of the ear-wearable device; inputting a representation of the ambient sound stream to a deep neural network that is trained to detect speech in a noisy environment; in response to detecting the speech via the deep neural network, causing the ear-wearable device to operate in a directional mode in which an audio representation derived from the ambient sound stream is emphasized in a target direction; in response to detecting no speech via the deep neural network, causing the ear-wearable device to operate in a spatial omnidirectional mode in which a fixed directional mode signal is combined with an omnidirectional signal to provide the audio representation, the fixed directional mode signal and the omnidirectional signal operating over different frequency ranges; and sending the audio representation to a receiver of the ear-wearable device for reproduction in an ear of a user.

Example 2 includes the method of example 1, wherein a gain of the omnidirectional signal is scaled to maintain a same overall noise perception level as would be perceived by a directional system in a noise-only condition. Example 3 includes the method of example 2, further comprising detecting motion of the user via an inertial measurement unit of the ear-wearable device, and wherein the omnidirectional signal is not scaled if the detected motion exceeds a threshold, and wherein the omnidirectional signal is scaled if the detected motion does not exceed the threshold.

Example 4 includes the method of example 1, 2, or 3, wherein the spatial omnidirectional mode causes the processor to divide the ambient sound stream into different first and second frequency-defined bands, first data corresponding to the first band used to provide the omnidirectional signal and second data corresponding to the second band used to provide the fixed directional mode signal. Example 5 includes the method of example 4, wherein a center frequency of the second band is higher than a corresponding center frequency of the first band. Example 6 includes the method of example 5, wherein the fixed directional mode signal provides fixed directionality in the second band to preserve localization cues. Example 7 includes the method of example 4, wherein the first band comprises a first set of first N-sub-bands and the second band comprises a second set of second N-sub-bands. Example 8 includes the method of example 7, wherein the first and second sets are disjoint.

Example 9 includes the method of any previous example, wherein the fixed directional mode signal has a static, cardioid polar pattern. Example 10 includes the method of any previous example, wherein the spatial omnidirectional mode enhances spatial information from a rear region of the user and reduces a noise level from a front region of the user. Example 11 includes the method of any previous example, wherein, in the spatial omnidirectional mode, the representation of the ambient sound stream sent into the deep neural network is processed in an adaptive directional mode to increase signal-to-noise ratio for speech detection. Example 12 includes the method of any previous example, wherein the deep neural network comprises at least one of a recurrent neural network, a transformer network, and an encoder-decoder.

Example 13 includes the method of any previous example, wherein an output of the deep neural network is a signal-to-noise ratio driven mask (SDM), and wherein a speech presence probability is estimated based on the SDM, the speech presence probability used to detect the speech. Example 14 includes the method of example 13, wherein SDM outputs are weighted with a speech intelligibility weighting function.

Example 15 includes the method of any previous example, wherein, in response to detecting no speech via the deep neural network and further in response to detecting low noise in the ambient sound stream, causing the ear-wearable device to operate in an omnidirectional mode. Example 16 includes the method of any previous example, wherein the spatial omnidirectional mode comprises a first spatial omnidirectional mode in which a first fixed directional mode signal is combined with a first omnidirectional signal to provide the audio representation, the method further comprising in response to detecting the speech via the deep neural network: determining whether the speech is on-axis speech that originates from a front region of the user or off-axis speech originating away from the front region; in response to detecting the on-axis speech, switching the ear-wearable device to operate in the directional mode; and in response to detecting the off-axis speech, switching the ear-wearable device to operate in a second spatial omnidirectional mode or a full omnidirectional mode, wherein the second spatial omnidirectional mode combines a second fixed directional mode signal with a second omnidirectional signal to provide the audio representation, wherein a gain of the second omnidirectional signal is different than a corresponding gain used to scale the first omnidirectional signal of the first spatial omnidirectional mode.

Example 17 is an ear-wearable device, comprising: two external microphones operable to convert ambient sound to respective two ambient sound streams; a receiver operable to reproduce sound in an ear of a user; and a processor coupled to the two external microphones and the receiver and operable to perform: inputting a representation of one or both of the ambient sound streams to a deep neural network that is trained to detect speech in a noisy environment; in response to detecting the speech via the deep neural network, causing the ear-wearable device to operate in a directional mode in which an audio representation derived from the ambient sound stream is emphasized in a target direction; in response to detecting no speech via the deep neural network, causing the ear-wearable device to operate in a spatial omnidirectional mode in which a fixed directional mode signal is combined with an omnidirectional signal to provide the audio representation, the fixed directional mode signal and the omnidirectional signal operating over different frequency ranges; and sending the audio representation to the receiver.

Example 18 includes the ear-wearable device of example 17, wherein a gain of the omnidirectional signal is scaled to maintain a same overall noise perception level as would be perceived by a directional system in a noise-only condition. Example 19 includes the ear-wearable device of example 18, further comprising an inertial measurement unit coupled to the processor, wherein the omnidirectional signal is not scaled if motion detected by the inertial measurement unit exceeds a threshold, and wherein the omnidirectional signal is scaled if the detected motion does not exceed the threshold.

Example 20 includes the ear-wearable device of example 17, 18, or 19, wherein the spatial omnidirectional mode comprises a first spatial omnidirectional mode in which a first fixed directional mode signal is combined with a first omnidirectional signal to provide the audio representation, the processor further configured to, in response to detecting the speech via the deep neural network: determining whether the speech is on-axis speech that originates from a front region of the user or off-axis speech originating away from the front region; in response to detecting the on-axis speech, switching the ear-wearable device to operate in the directional mode; and in response to detecting the off-axis speech, switching the ear-wearable device to operate in a second spatial omnidirectional mode or a full omnidirectional mode, wherein the second spatial omnidirectional mode combines a second fixed directional mode signal with a second omnidirectional signal to provide the audio representation, wherein a gain of the second omnidirectional signal is different than a corresponding gain used to scale the first omnidirectional signal of the first spatial omnidirectional mode.

Example 21 is a system comprising two ear-wearable devices as set forth in any one of examples 17-20, the system further comprising a synchronization module that performs: receiving, from the ear-wearable devices, directionality state data that is indicative of whether the directional mode or the spatial omnidirectional mode is being used by the ear-wearable devices; and based on the directionality state data, configuring at least one of the ear-wearable device to present a coherent and consistent sound field to the user.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification may be understood as being modified either by the term “exactly” or “about.” Accordingly, unless indicated to the contrary, the numerical parameters set forth in the foregoing specification are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A method of enhancing sound in an ear-wearable device, the method implemented via a processor of the ear-wearable device, the method comprising:
receiving an ambient sound stream from a microphone of the ear-wearable device;
inputting a representation of the ambient sound stream to a deep neural network that is trained to detect speech in a noisy environment;
in response to detecting the speech via the deep neural network, causing the ear-wearable device to operate in a directional mode in which an audio representation derived from the ambient sound stream is emphasized in a target direction;
in response to detecting no speech via the deep neural network, causing the ear-wearable device to operate in a spatial omnidirectional mode in which a fixed directional mode signal is combined with an omnidirectional signal to provide the audio representation, the fixed directional mode signal and the omnidirectional signal operating over different frequency ranges; and
sending the audio representation to a receiver of the ear-wearable device for reproduction in an ear of a user.

2. The method of claim 1, wherein a gain of the omnidirectional signal is scaled to maintain a same overall noise perception level as would be perceived by a directional system in a noise-only condition.

3. The method of claim 2, further comprising detecting motion of the user via an inertial measurement unit of the ear-wearable device, and wherein the omnidirectional signal is not scaled if the detected motion exceeds a threshold, and wherein the omnidirectional signal is scaled if the detected motion does not exceed the threshold.

4. The method of claim 1, wherein the spatial omnidirectional mode causes the processor to divide the ambient sound stream into different first and second frequency-defined bands, first data corresponding to the first band used to provide the omnidirectional signal and second data corresponding to the second band used to provide the fixed directional mode signal.

5. The method of claim 4, wherein a center frequency of the second band is higher than a corresponding center frequency of the first band.

6. The method of claim 5, wherein the fixed directional mode signal provides fixed directionality in the second band to preserve localization cues.

7. The method of claim 4, wherein the first band comprises a first set of first N-sub-bands and the second band comprises a second set of second N-sub-bands.

8. The method of claim 7, wherein the first and second sets are disjoint.

9. The method of claim 1, wherein the fixed directional mode signal has a static, cardioid polar pattern.

10. The method of claim 1, wherein the spatial omnidirectional mode enhances spatial information from a rear region of the user and reduces a noise level from a front region of the user.

11. The method of claim 1, wherein, in the spatial omnidirectional mode, the representation of the ambient sound stream sent into the deep neural network is processed in an adaptive directional mode to increase signal-to-noise ratio for speech detection.

12. The method of claim 1, wherein the deep neural network comprises at least one of a recurrent neural network, a transformer network, and an encoder-decoder.

13. The method of claim 1, wherein an output of the deep neural network is a signal-to-noise ratio driven mask (SDM), and wherein a speech presence probability is estimated based on the SDM, the speech presence probability used to detect the speech.

14. The method of claim 13, wherein SDM outputs are weighted with a speech intelligibility weighting function.

15. The method of claim 1, wherein, in response to detecting no speech via the deep neural network and further in response to detecting low noise in the ambient sound stream, causing the ear-wearable device to operate in an omnidirectional mode.

16. The method of claim 1, wherein the spatial omnidirectional mode comprises a first spatial omnidirectional mode in which a first fixed directional mode signal is combined with a first omnidirectional signal to provide the audio representation, the method further comprising in response to detecting the speech via the deep neural network:
determining whether the speech is on-axis speech that originates from a front region of the user or off-axis speech originating away from the front region;
in response to detecting the on-axis speech, switching the ear-wearable device to operate in the directional mode; and
in response to detecting the off-axis speech, switching the ear-wearable device to operate in a second spatial omnidirectional mode or a full omnidirectional mode, wherein the second spatial omnidirectional mode combines a second fixed directional mode signal with a second omnidirectional signal to provide the audio representation, wherein a gain of the second omnidirectional signal is different than a corresponding gain used to scale the first omnidirectional signal of the first spatial omnidirectional mode.

17. An ear-wearable device, comprising:
two external microphones operable to convert ambient sound to respective two ambient sound streams;
a receiver operable to reproduce sound in an ear of a user; and
a processor coupled to the two external microphones and the receiver and operable to perform:
inputting a representation of one or both of the ambient sound streams to a deep neural network that is trained to detect speech in a noisy environment;
in response to detecting the speech via the deep neural network, causing the ear-wearable device to operate in a directional mode in which an audio representation derived from the ambient sound stream is emphasized in a target direction;
in response to detecting no speech via the deep neural network, causing the ear-wearable device to operate in a spatial omnidirectional mode in which a fixed directional mode signal is combined with an omnidirectional signal to provide the audio representation, the fixed directional mode signal and the omnidirectional signal operating over different frequency ranges; and
sending the audio representation to the receiver.

18. The ear-wearable device of claim 17, wherein a gain of the omnidirectional signal is scaled to maintain a same overall noise perception level as would be perceived by a directional system in a noise-only condition.

19. The ear-wearable device of claim 18, further comprising an inertial measurement unit coupled to the processor, wherein the omnidirectional signal is not scaled if motion detected by the inertial measurement unit exceeds a threshold, and wherein the omnidirectional signal is scaled if the detected motion does not exceed the threshold.

20. The ear-wearable device of claim 17, wherein the spatial omnidirectional mode comprises a first spatial omnidirectional mode in which a first fixed directional mode signal is combined with a first omnidirectional signal to provide the audio representation, the processor further configured to, in response to detecting the speech via the deep neural network:
determining whether the speech is on-axis speech that originates from a front region of the user or off-axis speech originating away from the front region;
in response to detecting the on-axis speech, switching the ear-wearable device to operate in the directional mode; and
in response to detecting the off-axis speech, switching the ear-wearable device to operate in a second spatial omnidirectional mode or a full omnidirectional mode, wherein the second spatial omnidirectional mode combines a second fixed directional mode signal with a second omnidirectional signal to provide the audio representation, wherein a gain of the second omnidirectional signal is different than a corresponding gain used to scale the first omnidirectional signal of the first spatial omnidirectional mode.

21. A system comprising two ear-wearable devices as set forth in claim 17, the system further comprising a synchronization module that performs:
receiving, from the ear-wearable devices, directionality state data that is indicative of whether the directional mode or the spatial omnidirectional mode is being used by the ear-wearable devices; and
based on the directionality state data, configuring at least one of the ear-wearable device to present a coherent and consistent sound field to the user.
